(19) United States
(12) Patent Application Publication
(10) Pub. No.: US 2003/0089055 A1
(43) Pub. Date: May 15, 2003

(54) Vehicle window and method of producing the same

(75) Inventors: Toyoo Kawase, Atsugi-shi (JP); Kiyotaka Miyazawa, Atsugi-shi (JP); Kazuhiko Takeuchi, Atsugi-shi (JP); Kazuhiro Ichinohe, Atsugi-shi (JP)

Correspondence Address: GREENBLUM & BERNSTEIN, P.L.C., 1950 ROLAND CLARKE PLACE, RESTON, VA, 20191, US

(73) Assignee: HORI GLASS CO., LTD., Kanagawa (JP)

(21) Appl. No.: 10/284,416

(22) Filed: Oct. 31, 2002

Related U.S. Application Data
(63) Continuation-in-part of application No. 09/686,812, filed on Oct. 12, 2000, now Pat. No. 6,494,003.

(30) Foreign Application Priority Data
Mar. 24, 2000 (JP) 2000-128627

(51) Int. Cl. E06B 3/964; E06B 3/00

(52) U.S. Cl. 52/204.62; 52/208

(57) ABSTRACT

A vehicle window comprising: a window glass; a glass holder comprising a groove in which the window glass is inserted to be held by being nipped, and comprising a resin material selected from a natural grade of polybutylene terephthalate, a natural grade of a polyethylene terephthalate, a natural grade of a polybutylene terephthalate containing glass fibers, or a natural grade of polyethylene terephthalate containing glass fibers; and a one-liquid adhesive layer formed between the window glass and the groove by applying a liquid comprising a urethane and an epoxy-silane coupling agent.

### CROSS-REFERENCE TO RELATED APPLICATIONS

This application is a Continuation-In-Part of application. Ser. No. 09/686,812, filed Oct. 12, 2000, now allowed, the disclosure of which is incorporated herein by reference in its entirety. This application claims priority under 35 U.S.C. §119 of Japanese Application No. 2000-128627, filed Mar. 24, 2000.

### BACKGROUND OF THE INVENTION

1. Field of the Invention

The present invention relates to vehicle window assembled to an elevation apparatus and other apparatuses and a method of producing the same.

2. Description of the Related Art

As a means of assembling vehicle window glasses, there is known a glass holder structure using adhesives.

In a glass holder structure of this kind, a polyacetal resin or a polybutylene terephthalate resin containing glass fibers is used for a glass holder for holding a glass for a vehicle, a primer is applied on the glass side and on the glass holder side, one-liquid urethane adhesive or one-liquid silicone adhesive not containing silane coupling agent and two-liquid blending silicone are used for adhering for assembling.

The glass holder structure is for adhering a glass and a glass holder, but glasses are generally considered a hard to adhere material.

When assembling a vehicle window, it has been essential to use a primer for securing adhesive capability of the glass holder structure. The use of primer, however, requires a primer applying process, drying process and inspection process, and furthermore, a primer equipment and primer management. Also, means for improving the adhesive capability by using a primer requires a long time for the adhesives to set and a work for positioning a bracket requires a lot of efforts, which results in an increase in costs.

Furthermore, a work for applying the primer results in a bad working environment and deterioration in work efficiency due to the smell of the vaporized gas.

### SUMMARY OF THE INVENTION

An object of the present invention is to provide a vehicle window capable of attaining a low production costs, high adhesive effects and a compact mounting members, and a method of producing the same.

To attain the above objects, according to the first aspect of the present invention, there is provided a vehicle window comprising: a window glass; a glass holder comprising a groove in which the window glass is inserted to be held by being nipped, and comprising a resin material selected from a natural grade of polybutylene terephthalate, a natural grade of a polyethylene terephthalate, a natural grade of a polybutylene terephthalate containing glass fibers, or a natural grade of polyethylene terephthalate containing glass fibers; and a one-liquid adhesive layer formed between the window glass and the groove by applying a liquid comprising a urethane and an epoxy-silane coupling agent.

Also, to attain the above object, according to the second aspect of the present invention, there is provided a method of producing a vehicle window, comprising: providing a window glass; providing a glass holder comprising a groove in which the window glass is to be placed, the glass holder comprising a resin material selected from a natural grade of polybutylene terephthalate, a natural grade of a polyethylene terephthalate, a natural grade of a polybutylene terephthalate containing glass fibers, or a natural grade of polyethylene terephthalate containing glass fibers; providing a one-liquid adhesive comprising a urethane and a epoxy-silane coupling agent; and adhering the window glass to the holder groove using the adhesive.

On the surface of the vehicle window glass as one body to be adhered adsorbs water in the air wherein OH-group in the water and alkoxy-group in the silane coupling agent are bonded through a dehydrating condensation reaction.

The chemical structure of the polybutylene terephthalate resin or polyethylene terephthalate resin forming the glass holder as the other body to be adhered includes COO-group as a polar-group, thus, it is bonded with urethane bonding in the urethane sealant.

The one-liquid urethane sealant has isocyanate (NCO)-group at the end. After the isocyanate-group is bonded with water in the air, urea bonding is generated and hardened. As a result, the vehicle window glass and the glass holder are rapidly and firmly adhered by the urethane sealant being added the epoxy-silane coupling agent.

According to a vehicle window and a production method thereof of the present invention, it is possible to adhere between a vehicle glass and a glass holder furthermore firmly without using a glass primer nor a resin primer.

Also, a setting time of the adhesives, which has been long as a result of using a primer, can be made short. Accordingly, (1) abolition of primers on the glass side and on the resin side, (2) abolition of primer applying process, drying process, inspection process and equipments therefor, (3) abolition of primer management, (4) improvement of credibility in the market due to improvement in strength, (5) stabilization of quality and decrease in deficiency rate due to improvement of adhesive strength (particularly creep force) and reduction of unevenness in adhesive strength, (6) more compact members due to the improvement of adhesive strength, (7) reduction of adhering area due to an improvement of adhesive capability and (8) improvement of working environment by removing smells resulted from abolition of the primer applying process, can be attained and the economic effects is also large.

### BRIEF DESCRIPTION OF THE DRAWINGS

These and other objects and features of the present invention will be explained in more detail below with reference to the attached drawing, wherein:

FIG. 1 is a perspective view of a core portion for explaining an adhering condition of a vehicle window glass and a glass holder in the present invention,

FIG. 2 through to FIG. 9 are explanations of the adhesive mechanism of the invention through chemical formulae and schematics of the chemical reactions involved.

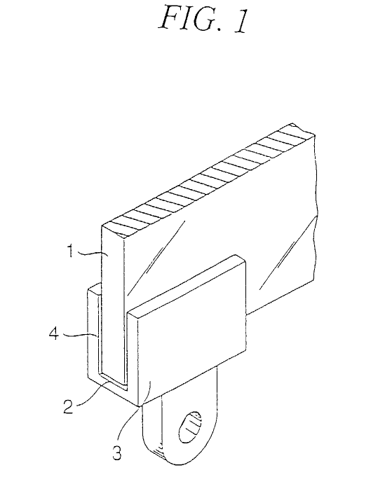

### DESCRIPTION OF THE PREFERRED EMBODIMENTS

A vehicle window glass 1 is held nipped by a U-shaped groove 2 formed on a glass holder 3 and firmly adhered with an adhesive 4.

The glass holder 3 is formed by a composite resin containing glass fibers in a natural grade of polybutylene terephthalate resin as a resin material having COO-group as a polar-group or in a natural grade of a polybutylene terephthalate resin. Alternately, instead of the above, it may be formed by a composite resin containing glass fibers in a natural grade of a polyethylene terephthalate resin as a resin material having COO-group as a polar-group or in a natural grade of a polyethylene terephthalate resin.

As the adhesive 4, an urethane adhesive of one liquid type containing epoxy-silane coupling agent is used.

The following will explain, from the perspective of the chemical reactions, the adhesion process of PBT resin-based or PET resin-based glass holders 3 to vehicle window glass using the one-liquid type urethane adhesive containing epoxy-silane coupling agent.

Firstly, the bonding process between the glass 1 and the one-liquid type urethane adhesive containing epoxy-silane coupling agent is as follows:

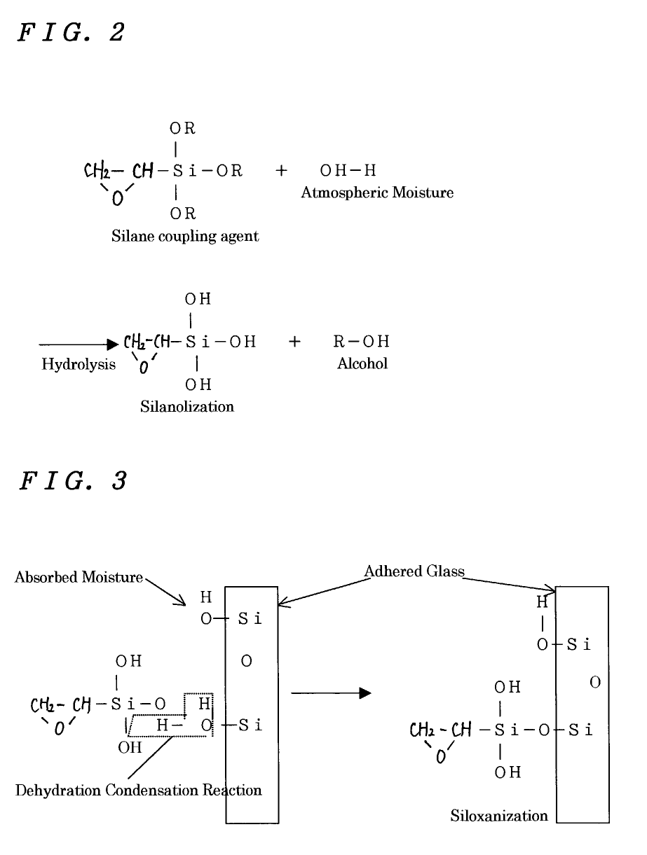

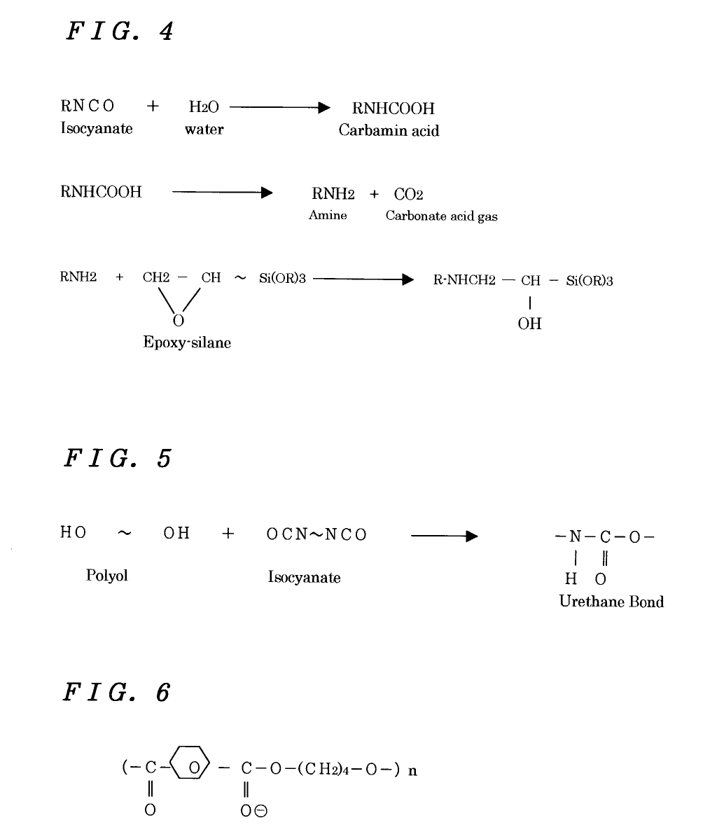

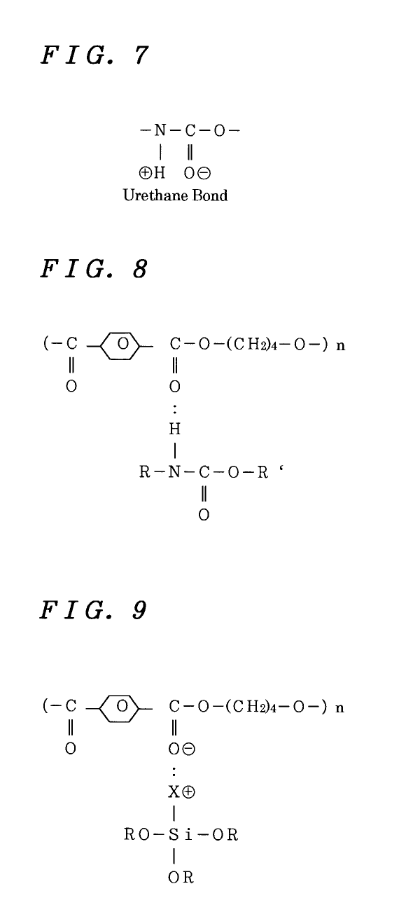

This process, as shown in FIG. 2, shall entail the bonding of the one-liquid type urethane adhesive containing epoxy-silane coupling agent. This bonding is completed when the epoxide group (CH₂—CH—O—) and a silicon atom (Si) extends to alkoxy-group (OR). Contact with the atmospheric moisture (OH—H) results in hydrolytic dissociation and silanolization whereby alcohol is generated and discharged in course.

The epoxy-silane coupling agent, having undergone the silanolization process, will, in the location where it comes into contact with the glass, absorb water due to a dehydrating condensation reaction, as shown in FIG. 3. Said water will evaporate into the atmosphere. The glass 1 and the epoxy-silane coupling agent will thereby form a solid siloxane bond.

With regard to this process, the isocyanate (R—NCO) with its urethane end, as shown in FIG. 4, will react with water (H₂O) in the atmosphere, as a result carbamic acid (RNHCOOH) is generated. This carbamic acid (RNHCOOH) will be resolved into amine (RNH₂) and carbonic acid gas (CO₂). Furthermore, the epoxide group (CH₂—CH—O—) that forms the end section of the epoxy-silane coupling agent, as shown in FIG. 4, will react with the amine (RNH₂).

Moreover, the one-liquid type urethane adhesive, as shown in FIG. 5, will react with the OH group polyol and the isocyanate (OCN—NCO) to form a urethane bond. Through these reactions and processes, the bond between the glass and the one-liquid type urethane adhesive containing epoxy-silane coupling agent is further solidified.

Hereinafter follows an explanation of the bonding mechanism between the polybutylene terephthalate or the polyethylene terephthalate resin and the urethane adhesive. This explanation shall be in terms of the chemical reactions involved. Note that this explanation uses polybutylene terephthalate, however polyethylene terephthalate also has the same working mechanism.

Polybutylene terephthalate, as described in the chemical structure formula shown in FIG. 6, uses a strongly polarized ester group (—COO). Ester bonding consists of a group of negatively charged aspirated atoms.

On the other hand, the above adhesion reactions caused by the NH bonding part of the urethane bonding reaction is described as FIG. 7. Bonding of this nature consists of a group of positively charged electrons.

Therefore, as shown in FIG. 8, within the bonding reaction between polybutylene terephthalate resin and urethane adhesive, there is a transfer of electrons that strengthens the bond. Moreover, as shown in FIG. 9, the urethane sealant is added to the epoxy-silane coupling agent and the resulting reaction by epoxide group X (CH₂—CH—O—) creates an even stronger bond.

In this fashion, a firm bonds form between the glass and the polybutylene terephthalate through the one-component urethane adhesive containing the epoxy-silane coupling agent.

### EXAMPLE

After a one-liquid adhesive comprising a urethane and a epoxy-silane coupling agent was applied to a window glass and a glass holder comprising a polybutylene terephthalate resin, tensile strength test was carried out (1) at 24 hours passage under room temperature, (2) at 48 hours passage under room temperature, (3) at 168 hours passage under room temperature, (4) at 168 hours passage under 38 Celsius & 95% relative humidity, (5) at 168 hours passage under −40 Celsius, and (6) at 336 hours passage under 79 Celsius. The purpose of the test (1) is to confirm an initial tensile strength, the purpose of the test (2) is to confirm a tensile strength on the way of hardening, the purpose of the test (3) is to confirm a final tensile strength, the purpose of the test (4) is to confirm a moisture-proof, the purpose of the test (5) is to confirm a cold-proof, the purpose of the test (6) is to confirm a durability. The results of these tests are shown in Table 1.

### Comparative Example

After a one-liquid adhesive comprising a urethane and a amino-silane coupling agent was applied to a window glass and a glass holder comprising a polybutylene terephthalate resin, tensile strength test was carried out above same tests (1)-(6). The results of these tests are shown in Table 1.

TABLE 1

| Tensile strength Test | Example | Comparative |
|---|---|---|
| (1) 24H, Room Temp | 849 N | 2393 N |
| (2) 48H, Room Temp | 2810 N | 5205 N |
| (3) 168H, Room Temp | 6449 N | 5756 N |
| (4) 38C, 95% RH, 168H | 5680 N | 5483 N |
| (5) −40C, 168H | 6631 N | 5916 N |
| (6) 79C, 336H | 7015 N | 5889 N |

It is understood by above result of tests that the a one-liquid adhesive comprising a urethane and a epoxy-silane coupling agent according to the present invention is superior to a one-liquid adhesive comprising a urethane and a amino-silane coupling agent in test (3)-(6).

Note that the embodiments explained above were described to facilitate the understanding of the present invention and not to limit the present invention. Accordingly, elements disclosed in the above embodiments include all design modifications and equivalents belonging to the technical field of the present invention.

1. A vehicle window comprising:
a window glass;
a glass holder comprising a groove in which the window glass is inserted to be held by being nipped, and comprising a resin material selected from a natural grade of polybutylene terephthalate, a natural grade of a polyethylene terephthalate, a natural grade of a polybutylene terephthalate containing glass fibers, or a natural grade of polyethylene terephthalate containing glass fibers; and
a one-liquid adhesive layer formed between the window glass and the groove by applying a liquid comprising a urethane and an epoxy-silane coupling agent.

2. The vehicle window of claim 1, wherein the epoxy-silane coupling agent is present in the liquid in an amount of not more than about 5 wt %.

3. The vehicle window of claim 1, wherein the adhesive layer does not include a primer.

4. The vehicle window of claim 2, wherein the adhesive layer does not include a primer.

5. A method of producing a vehicle window, comprising:
providing a window glass;
providing a glass holder comprising a groove in which the window glass is to be placed, the glass holder comprising a resin material selected from a natural grade of polybutylene terephthalate, a natural grade of a polyethylene terephthalate, a natural grade of a polybutylene terephthalate containing glass fibers, or a natural grade of polyethylene terephthalate containing glass fibers;
providing a one-liquid adhesive comprising a urethane and a epoxy-silane coupling agent; and
adhering the window glass to the holder groove using the adhesive.

6. The method of claim 5, wherein the epoxy-silane coupling agent is present in the liquid in an amount of not more than about 5 wt %.

7. The method of claim 5, wherein a primer is not applied.

8. The method of claim 6, wherein a primer is not applied.
